(19) United States
(12) Patent Application Publication
(10) Pub. No.: US 2006/0042095 A1
(43) Pub. Date: Mar. 2, 2006

(54) Comb-vibration preventing structure for hair cutter

(75) Inventors: Takashi Yamaguchi, Hikone-shi (JP); Hitoshi Ogawa, Inukami-gun (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/211,637

(22) Filed: Aug. 26, 2005

(30) Foreign Application Priority Data
Sep. 1, 2004 (JP) 2004-254009

(51) Int. Cl. B26B 19/00

(52) U.S. Cl. 30/201

(57) ABSTRACT

Disclosed is a comb-vibration preventing structure for a hair cutter including a cutter body 4 and a cutting-length adjusting comb 3 adapted to be fitted on an upper portion of the cutter body 4 and vertically moved in a sliding manner so as to adjust a cutting length. The comb-vibration preventing structure comprises a wire spring (elastic member) 10 for urging each of opposite inner side surfaces 3a, 3b of the cutting-length adjusting comb 3 in an outward thrusting manner in an opposite lateral direction P. The comb-vibration preventing structure can prevent vibrations of the cutting-length adjusting comb to reduce chatter noises, and achieve enhanced usability while facilitating quality control.

### FIELD OF THE INVENTION

The present invention relates to an improvement of a comb-vibration preventing structure for a hair clipper or cutter.

### DESCRIPTION OF THE BACKGROUND ART

Heretofore, there has been known a hair cutter comprising a cutter body and a cutting-length adjusting comb adapted to be fitted on an upper portion of the cutter body and vertically moved in a sliding manner so as to adjust a cutting length of hair or beard as shown in Japanese Patent Laid-Open Publication No. 01-214388

As for a mounting technique disclosed in this Patent Publication, the cutting-length adjusting comb is simply fitted on the upper portion of the cutter body. Thus, the cutting-length adjusting comb is liable to shake or wobble due to lateral vibrations in a blade block and cause a problem about occurrence of chatter noises.

While this wobbling may be avoided by improving a fitting accuracy of the cutting-length adjusting comb relative to the cutter body, this approach involves problems about poor usability due to increase in sliding resistance of the cutting-length adjusting comb, and difficulties in quality control.

### SUMMARY OF THE INVENTION

In view of the above problems, it is an object of the present invention to provide a comb-vibration preventing structure for a hair cutter which can prevent vibrations of a cutting-length adjusting comb to reduce chatter noises, and achieve enhanced usability while facilitating quality control.

According to an aspect of the present invention, a comb-vibration preventing structure for a hair cutter is provided with a cutter body and a cutting-length adjusting comb detachably adapted to be fitted on an upper portion of the cutter body and vertically moved in a sliding manner so as to adjust a cutting length.

The comb-vibration preventing structure comprises an elastic member for urging each of opposite inner side surfaces of the cutting-length adjusting comb in an outward thrusting manner in an opposite lateral direction.

Other features and advantages of the present invention will be apparent from the accompanying drawings and from the detailed description.

### BRIEF DESCRIPTION OF DRAWINGS

FIG. 1 is a perspective view showing a hair cutter having a comb-vibration preventing structure according to an embodiment of the present invention.

FIG. 2 is an exploded perspective view showing the hair cutter in the state after a blade block and a cutting-length adjusting comb are detached therefrom.

FIG. 3 is a front view showing the hair cutter in the state after the cutting-length adjusting comb is detached therefrom.

FIGS. 4A to 4C show the cutting-length adjusting comb, wherein FIG. 4A is a front view thereof, FIG. 4B is a bottom view thereof, and FIG. 4C is a sectional view taken along the line 4C-4C in FIG. 4A.

FIGS. 5A and 5B show a cutter body and a wire spring, wherein FIG. 5A is a perspective view thereof in the state after the wire spring is incorporated in the cutter body, and FIG. 5B is a perspective view thereof in the state before the wire spring is incorporated in the cutter body.

FIGS. 6A and 6B schematically show an upper portion of the cutter body and the cutting-length adjusting comb, wherein FIG. 6A is a sectional view thereof in the state after the cutting-length adjusting comb is attached to the cutter body, and FIG. 6B is a sectional view thereof in the state after the cutting-length adjusting comb is detached therefrom.

FIGS. 7A and 7B show a hair cutter as a comparative example, wherein FIG. 7A is a partly sectional side view thereof in the state after a cutting-length adjusting comb is slidingly moved to the uppermost position, and FIG. 7B is a partly sectional side view thereof in the state after the cutting-length adjusting comb is slidingly moved to the lowermost position.

FIG. 8 is a perspective view showing the comparative example.

### DESCRIPTION OF THE PREFERRED EMBODIMENTS OF THE INVENTION

With reference to the drawings, the best mode for implementing the present invention will now be described in detail.

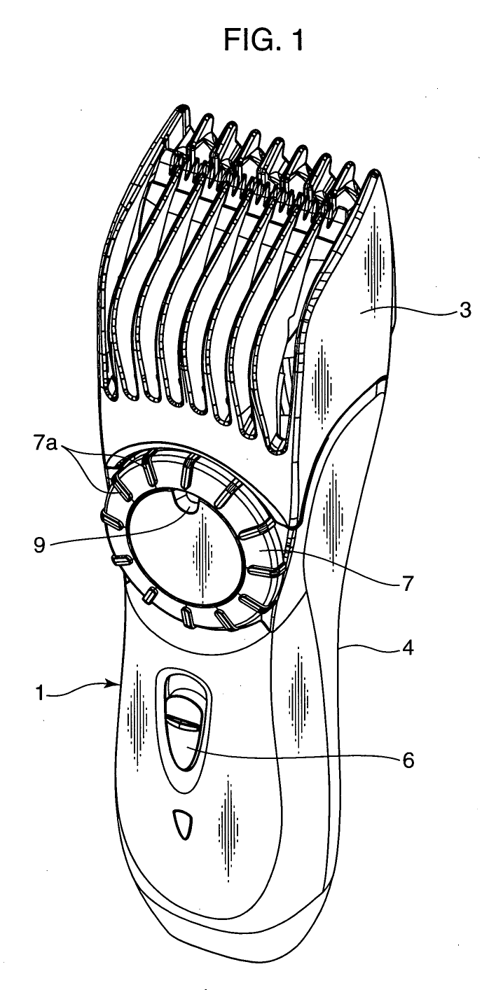

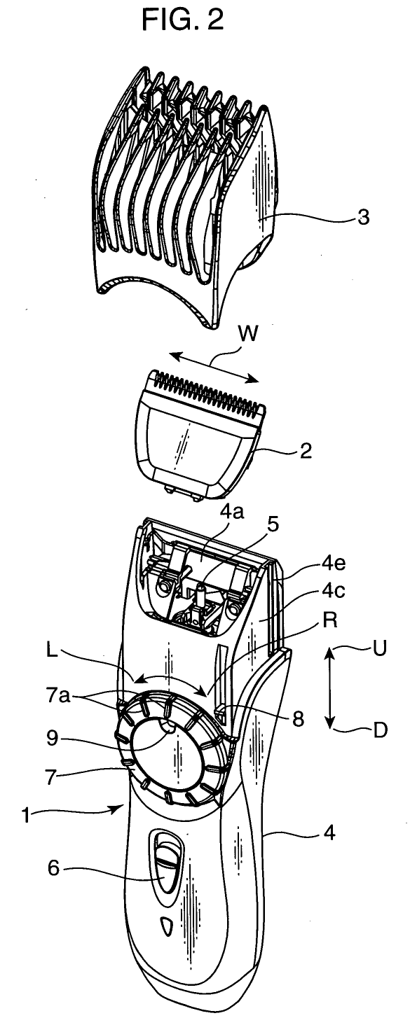

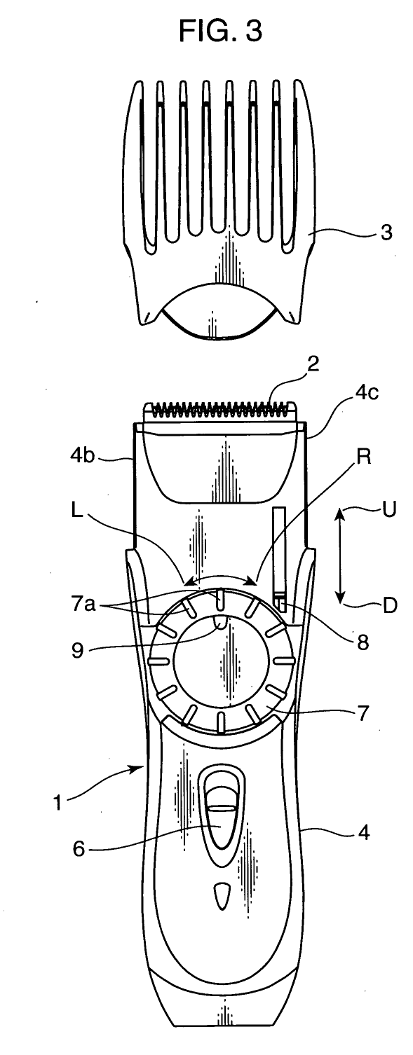

FIG. 1 is a perspective view showing a hair cutter 1 having a comb-vibration preventing structure according to an embodiment of the present invention. FIG. 2 is an exploded perspective view showing the hair cutter 1 in the state after a blade block 2 and a cutting-length adjusting comb 3 are detached therefrom, and FIG. 3 is a front view showing the hair cutter 1 in the state after the cutting-length adjusting comb 3 is detached therefrom.

The hair cutter 1 includes a cutter body 4 formed to have an outer shape suitable for being gripped with one hand. The cutter body 4 has an upper-end opened space 4a formed to allow a blade block 2 to be detachably attached thereto.

The blade block 2 comprises a stationary blade and a movable blade. The movable blade is adapted to be engaged with a driving pin 5 (see FIG. 2) located inside the upper-end opened space 4a of the cutter body 4. This driving pin 5 is designed to be reciprocated in a lateral direction W at a high speed by an electric motor housed in the cutter body 4. Thus, hair or beard can be cut by the movable blade reciprocated in the lateral direction W at a high speed by the driving pin 5.

The cutter body 4 has a front surface provided with a slide switch 6 for turning on/off the electric motor for reciprocating the driving pin 5, and a manual operation dial 7 for vertically moving the cutting-length adjusting comb 3 in a sliding manner.

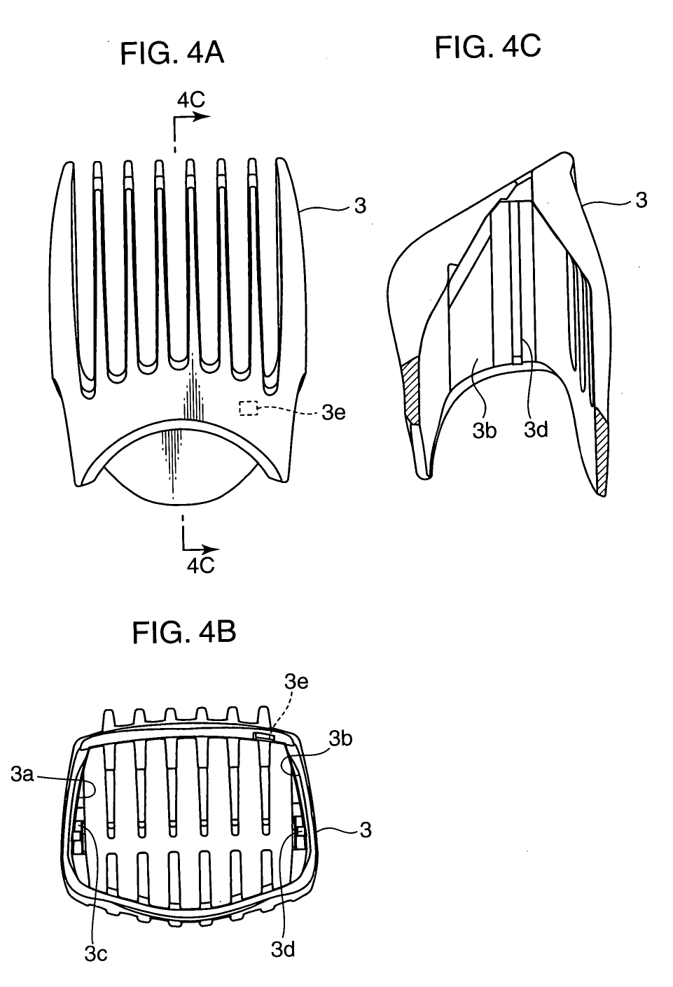

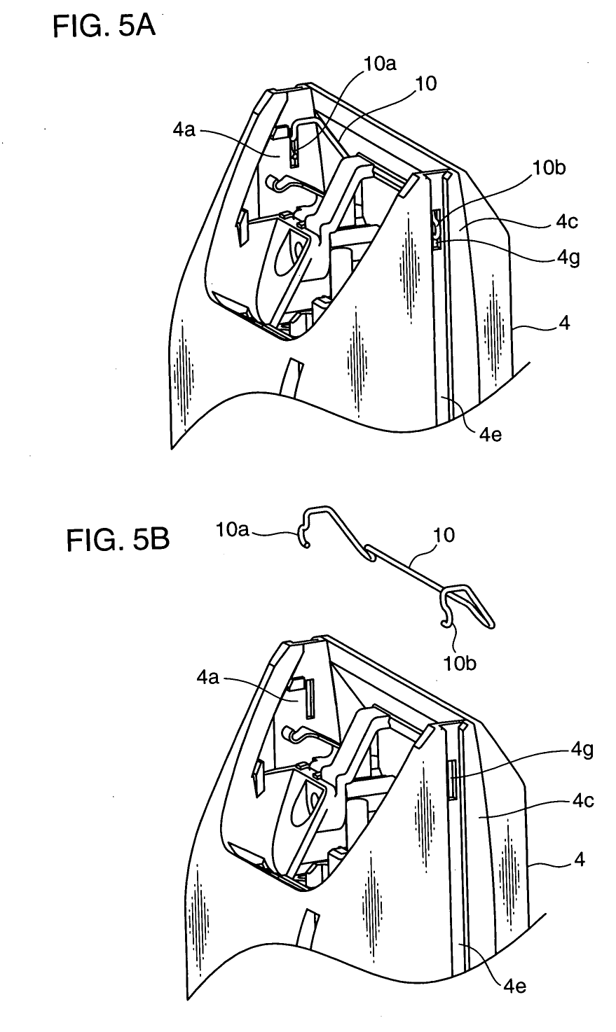

As shown in detail in FIGS. 4A to 6B, an upper portion of the cutter body 4 has opposite outer side surfaces formed, respectively, with two vertically-extending line-shaped guide grooves 4d, 4e, and the cutting-length adjusting comb 3 has opposite inner side surfaces formed, respectively, with two vertically-extending line-shaped guide protrusions 3c, 3d engageable with the corresponding guide grooves 4d, 4e.

The cutting-length adjusting comb 3 is designed to be fitted on the upper portion of the cutter body 4 with an appropriate gap therebetween in such a manner as to cover over the blade block 2 attached to the upper end of the cutter body 4. Further, when the cutting-length adjusting comb 3 is fitted on the upper portion of the cutter body 4, the guide protrusions 3c, 3d of the cutting-length adjusting comb 3 will be engaged with and guided by the corresponding guide grooves 4d, 4e of the cutter body 4, to allow the cutting-length adjusting comb 3 to be vertically moved in a sliding manner smoothly relative to the cutter body 4.

As shown in FIGS. 2 and 3, the front surface of the cutter body 4 is also provided with a hook member 8 adapted to be moved in conjunction with a rotating operation of the manual operation dual 7 through an interlocking mechanism (pinion, rack, etc.) interlocked with the rotating operation of the manual operation dual 7, for example, in a downward direction D and in an upward direction U when the manual operation dual 7 is manually rotated, respectively, in a clockwise direction R and in a counterclockwise direction L. When the cutting-length adjusting comb 3 is fitted on the upper portion of the cutter body 4, this hook member 8 will be detachably engaged with a hook groove 3e (see FIGS. 4A and 4B) of the cutting-length adjusting comb 3.

Then, when the hook member 8 is moved in the downward direction D in conjunction with the operation of the manual operation dual 7 in the clockwise direction R, the cutting-length adjusting comb 3 is slidingly moved in the downward direction D by the hook member 8. Conversely, when the hook member 8 will be moved in the upward direction U in conjunction with the operation of the manual operation dual 7 in the counterclockwise direction L, the cutting-length adjusting comb 3 will be slidingly moved in the upward direction U by the hook member 8.

The manual operation dial 7 has a front surface formed with a plurality of indicator protrusions 7a at even intervals in a circumferential direction to additionally serve as a finger gripper or slip stopper. The manual operation dial 7 is also associated with a click mechanism (not shown) for providing a click feeling, for example, at each trisected position between the adjacent indicator protrusions 7a. The front surface of the cutter body 4 is further provided with a window 9 located on the inward side of the manual operation dial 7 and designed to indicate a numerical character (e.g. 1 to 12) assigned correspondingly to each of the indicator protrusions 7a of the manual operation dial 7 to give an index of a cutting length.

As shown in 5A to 6B, two through-holes 4f, 4g are formed in the cutter body 4, respectively, at positions adjacent to upper ends of the guide grooves 4d, 4e, to penetratingly extend from the bottoms of the corresponding guide grooves 4d, 4e into the upper-end opened space 4a.

A single wire spring (elastic member) 10 is prepared to have opposite ends formed, respectively, with contact portions 10a, 10b bent in an outward-protruding U shape. This wire spring 10 is fitted into the upper-end opened space 4a of the cutter body 4 in such a manner as to allow the contact portions 10a, 10b to protrude from the corresponding through-holes 4f, 4g into the upper end regions of the corresponding guide grooves 4d, 4e.

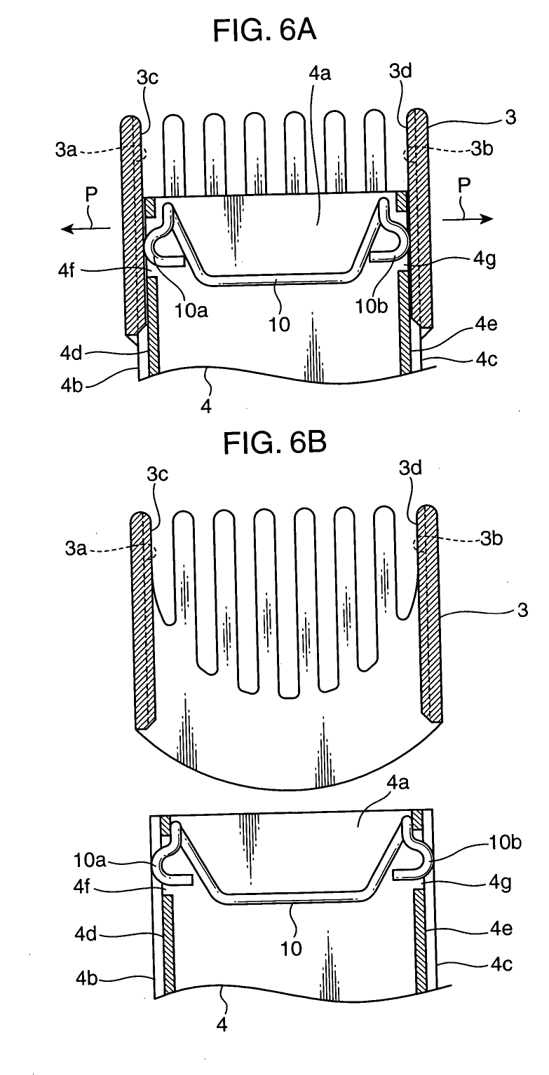

When the cutting-length adjusting comb 3 is fitted on the upper portion of the cutter body 4, the contact portions 10a, 10b of the wire spring 10 will come into contact with the corresponding guide protrusions 3c, 3d of the cutting-length adjusting comb 3 engaged with the guide grooves 4d, 4e of the cutter body 4, and urge each of opposite inner side surfaces 3a, 3b of the cutting-length adjusting comb 3 in an outward thrusting manner in an opposite lateral direction (see the arrow P in FIG. 6A).

According to the hair cutter 1 having the above comb-vibration preventing structure, the wire spring 10 can urge each of opposite inner side surfaces 3a, 3b of the cutting-length adjusting comb 3 in an outward thrusting manner in the opposite lateral direction P. This makes it possible to prevent a wobbling movement of the cutting-length adjusting comb 3 without the need for improving a fitting accuracy of the cutting-length adjusting comb 3 relative to the cutter body 4, so that the occurrence of chatter noises can be reduced. In particular, the structure designed to thrust the opposite inner side surfaces 3a, 3b of the cutting-length adjusting comb 3 in the same directions as the reciprocating directions of the blade block 2 by the wire spring 10 can effectively prevent a wobbling movement of the cutting-length adjusting comb 3. In addition, this function is achieved only by urging the cutting-length adjusting comb 3 in an outward thrusting manner in the opposite lateral direction P through the use of the wire spring 10. Thus, the sliding movement of the cutting-length adjusting comb 3 can be smoothly performed to provide enhanced usability.

Further, in the above comb-vibration preventing structure, the wire spring 10 fixed to the cutter body 4 is designed to come into contact with the guide protrusions 3c, 3d formed on the opposite inner side surfaces 3a, 3b of the cutting-length adjusting comb 3. Thus, the wire spring 10 can have a fixed contact position, and only the guide protrusions 3c, 3d formed on the opposite inner side surfaces 3a, 3b of the cutting-length adjusting comb 3 can have scratches due to the contact with the wire spring 10. This makes it possible to prevent deterioration in appearance.

The guide grooves 4d, 4e engageable with the guide protrusions 3c, 3d of the opposite inner side surfaces 3a, 3b of the cutting-length adjusting comb 3 are formed in opposite outer side surfaces 4b, 4c of the cutter body 4. This allows the cutting-length adjusting comb 3 to be slidingly moved smoothly along the cutter body 4. In addition, the contact portions 10a, 10b of the wire spring 10 contained in the guide grooves 4d, 4e can provide enhanced appearance.

Further, the wire spring 10 is comprised of a single wire spring, and the opposite ends of the wire spring 10 are formed with the contact portions 10a, 10b adapted to come into contact with the guide grooves 3c, 3d. Thus, an additional component can be limited to only the single wire spring 10 to provide a simplified structure at low cost.

The wire spring 10 is supported by the through-holes 4f, 4g allowing the contact portions 10a, 10b to protrude into the guide grooves 4d, 4e. This makes it possible to eliminate the need for an additional retainer so as to provide a more simplified structure at lower cost.

Furthermore, the wire spring 10 is disposed in the upper end region of the cutter body 4. This makes it possible to prevent a wobble movement of the cutting-length adjusting comb 3 over the entire stroke of the cutting-length adjusting comb 3 only by the single wire spring 10.

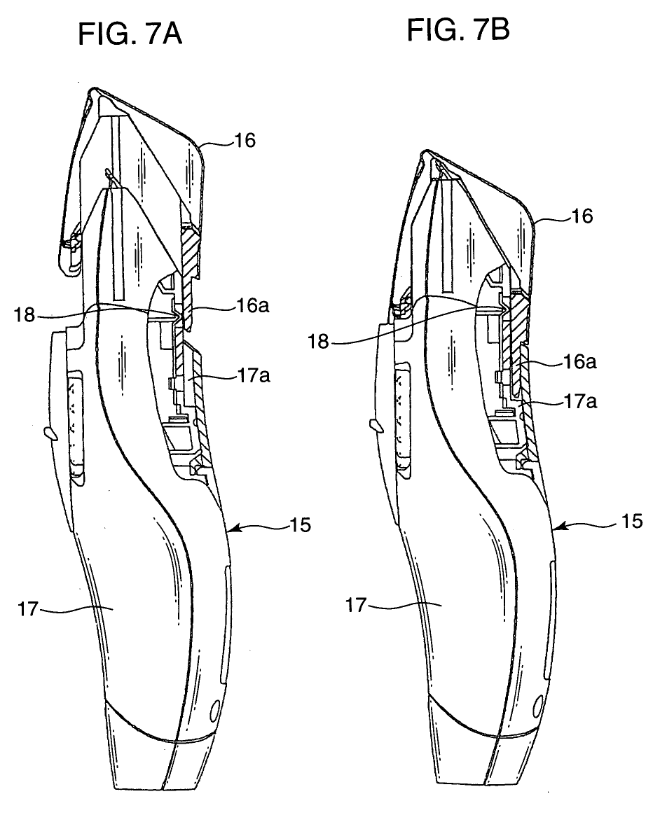

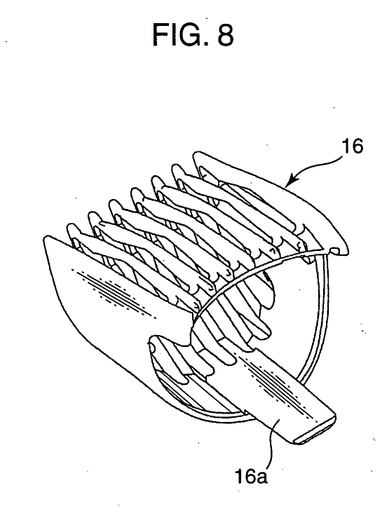

FIGS. 7A, 7B and 8 show a hair cutter 15 as a comparative example. This hair cutter 15 comprises a cutting-length adjusting comb 16 having a back lower end formed with an insertion portion 16a extending downward. This hair cutter 15 is designed to insert a part of the insertion portion 16a into a receiving groove 17a formed in a cutter body 17, and pressingly urge the insertion portion 16a backward by a leaf spring (elastic member) 18 disposed inside a cutter body 17, so as to prevent a wobbling movement of the cutting-length adjusting comb 16 to reduce chatter noises.

This comparative structure is required to have the insertion portion 16a formed in the cutting-length adjusting comb 16, and the receiving groove 17a formed in the cutter body 17. This requirement causes a problem about increased restrictions in design. Moreover, scratches formed in the insertion portion 16a due to the contact with the leaf spring 18 will cause a problem about deteriorated appearance when the cutting-length adjusting comb 16 is detached from the cutter body 17.

In contrast, the comb-vibration preventing structure according to the above embodiment is designed to urge each of the opposite inner side surfaces 3a, 3b of the cutting-length adjusting comb 3 in an outward thrusting manner in the opposite lateral direction P. Thus, the need for providing the insertion portion 16a and the receiving groove 17a can be eliminated to reduce restrictions in design. In addition, only the guide protrusions 3c, 3d of the opposite inner side surfaces 3a, 3b of the cutting-length adjusting comb 3 can have scratches due to the contact with the wire spring 10. Thus, even after the cutting-length adjusting comb 3 is detached from the cutter body 4, the scratched guide protrusions 3c, 3d of the opposite inner side surfaces 3a, 3b are unlikely to be seen from the outside. This makes it possible to provide enhanced appearance.

As described above, a comb-vibration preventing structure for a hair cutter is provided with a cutter body and a cutting-length adjusting comb detachably adapted to be fitted on an upper portion of the cutter body and vertically moved in a sliding manner so as to adjust a cutting length. The comb-vibration preventing structure comprises an elastic member for urging each of opposite inner side surfaces of the cutting-length adjusting comb in an outward thrusting manner in an opposite lateral direction.

The comb-vibration preventing structure may be preferably designed such that the opposite inner side surfaces of the cutting-length adjusting comb are formed, respectively, with line-shaped guide protrusions, and the elastic member is adapted to come into contact with the respective guide protrusions.

The cutter body may have opposite outer side surfaces formed, respectively, with line-shaped guide grooves. In this case, the elastic member may be at least partly located in the respective guide grooves.

The elastic member may be comprised of a single wire spring having opposite ends formed, respectively, with contact portions adapted to come into contact with the corresponding guide protrusions.

Further, the cutter body may be formed with a through-hole supporting the wire spring in such a manner as to allow the contact portions to protrude into the corresponding guide grooves.

The wire spring may be disposed in an upper end region of the cutter body.

The comb-vibration preventing structure is designed to urge each of the opposite inner side surfaces of the cutting-length adjusting comb in an outward thrusting manner in an opposite lateral direction by means of the elastic member. This makes it possible to prevent a wobbling movement of the cutting-length adjusting comb without the need for improving a fitting accuracy of the cutting-length adjusting comb relative to the cutter body, so that the occurrence of chatter noises can be reduced. In addition, this function is achieved only by urging the cutting-length adjusting comb in an outward thrusting manner in an opposite lateral direction through the use of the elastic member. Thus, the sliding movement of the cutting-length adjusting comb can be smoothly performed to provide enhanced usability.

This application is based on patent application No. 2004-254009 filed in Japan, the contents of which are hereby incorporated by references.

An advantageous embodiment of the invention has been shown and described. It is obvious to those skilled in the art that various changes and modifications may be made therein without departing from the spirit and scope thereof as set forth in appended claims.

What is claimed is:

1. A comb-vibration preventing structure for a hair cutter including a cutter body and a cutting-length adjusting comb adapted to be fitted on an upper portion of the cutter body and vertically moved in a sliding manner so as to adjust a cutting length, the comb-vibration preventing structure comprising an elastic member for urging each of opposite inner side surfaces of the cutting-length adjusting comb in an outward thrusting manner in an opposite lateral direction.

2. The comb-vibration preventing structure as defined in claim 1, wherein the opposite inner side surfaces of the cutting-length adjusting comb are formed, respectively, with line-shaped guide protrusions, and the elastic member is adapted to come into contact with the respective guide protrusions.

3. The comb-vibration preventing structure as defined in claim 2, wherein the cutter body has opposite outer side surfaces formed, respectively, with line-shaped guide grooves, wherein the elastic member is at least partly located in the respective guide grooves.

4. The comb-vibration preventing structure as defined in claim 3, wherein the elastic member is comprised of a single wire spring which has opposite ends formed, respectively, with contact portions adapted to come into contact with the corresponding guide protrusions.

5. The comb-vibration preventing structure as defined in claim 4, wherein the wire spring is disposed in an upper end region of the cutter body.

6. The comb-vibration preventing structure as defined in claim 4, wherein the cutter body is formed with a through-hole supporting the wire spring in such a manner as to allow the contact portions to protrude into the corresponding guide grooves.

7. The comb-vibration preventing structure as defined in claim 6, wherein the wire spring is disposed in an upper end region of the cutter body.

8. The comb-vibration preventing structure as defined in claim 2, wherein the elastic member is comprised of a single wire spring which has opposite ends formed, respectively, with contact portions adapted to come into contact with the corresponding guide protrusions.
